(19) United States
(12) Patent Application Publication
(10) Pub. No.: US 2018/0365682 A1
(43) Pub. Date: Dec. 20, 2018

(54) MULTI-SCHEME PAYMENT MOBILE DEVICE AND SYSTEM

(71) Applicant: SimSec Hong Kong Limited, Hong Kong (HK)

(72) Inventors: David C. BALL, Queensland (AU); Marcus D. LEMESSURIER, Queensland (AU)

(21) Appl. No.: 15/778,536

(22) PCT Filed: Nov. 21, 2016
(86) PCT No.: PCT/AU2016/051130

§ 371 Date: May 23, 2018

(30) Foreign Application Priority Data
Nov. 30, 2015 (AU) 2015904945

(51) Int. Cl. G06Q 20/34; G06Q 20/32; G06Q 20/38; G06Q 20/40

(52) U.S. Cl. CPC G06Q 20/353; G06Q 20/341; G06Q 20/4012; G06Q 20/385; G06Q 20/3278

(57) ABSTRACT

A mobile electronic device is configured to perform an intended purpose and further configured to effect a financial transaction in addition to the intended purpose. The device includes a first group of electronic circuits configured to facilitate the performing of the intended purpose; and a second group of electronic circuits configured to effect the financial transaction. The first group of electronic circuits is communicatively isolated from the second group of electronic circuits.

### FIELD OF INVENTION

The present invention relates to a mobile device and systems for effecting financial transactions. The present invention has particular but not exclusive application with electronic payment methods.

### BACKGROUND OF THE INVENTION

It is not uncommon for people to possess more than one credit, debit, or other electronic payment card. Owning more than one electronic payment card inevitably results in a person having to carry with them each of such cards. Carrying multiple cards is, however, inconvenient.

A solution to carrying multiple cards is to embed in a single card multiple primary account numbers (PAN), one for each payment scheme to be provided by the one card. Such a solution, however, requires each of the payment schemes (for example, Visa™, Mastercard™, American Express™, and the like) to agree to cooperate and collaborate. For various reasons, including each scheme wanting to maintain and promote individual branding and identity, such a solution is unfeasible.

### OBJECT OF THE INVENTION

It is an object of the present invention to provide a mobile device and system that securely incorporates and integrates therein a digital and/or logical electronic payment card, and which card is operable to facilitate electronic payments via a number of different payment schemes using existing electronic financial systems.

### SUMMARY OF THE INVENTION

The invention in one aspect broadly resides in a mobile electronic device configured to perform an intended purpose and further configured to effect a financial transaction in addition to the intended purpose, the device including:

a first group of electronic circuits configured to facilitate the performing of the intended purpose; and

a second group of electronic circuits configured to effect the financial transaction, wherein

the first group of electronic circuits is communicatively isolated from the second group of electronic circuits.

Preferably when there is input and output to and from the first group of electronic circuits is permitted, input and output to and from the second group of electronic circuits is denied.

The second group of electronic circuits preferably includes an EMV (Europay, Mastercard, Visa) standard integrated circuit for effecting financial transactions using the EMV payment standard.

The second group of electronic circuits preferably includes an electronic dock adapted to removably receive therein an electronic chip, the electronic chip containing some or all of the electronic circuits of the second group.

The device in a preferred embodiment further includes a switch for switching between a first mode of operation where input and output to and from the first group of electronic circuits is permitted, and a second mode of operation where input and output to and from the second group of electronic circuits is permitted.

A device according to claim 1, wherein input and output to and from the first group of electronic circuits is permitted at the same time that input and output from the second group of electronic circuits is permitted.

Preferably, the first group of electronic circuits comprises a near-field-communication (NFC) receiver and the second group of electronic circuits comprises an NFC transmitter, and further wherein the second group of electronic circuits is operable to communicate data to the first group of electronic circuits via NFC communication.

Preferably, the first group of electronic circuits is communicatively isolated from the second group of electronic circuits by way of a logical virtual machine architecture.

In another form, the first group of electronic circuits is communicative isolated from the second group of electronic circuits by a physical separation.

Preferably, the second group of electronic circuits is operable to generate a one-time passcode (OTP) for authenticating the financial transaction.

Preferably, the second group of electronic circuits is operable to generate a one-time passcode (OTP) for authenticating the financial transaction.

Preferably, the second group of electronic circuits is operable to transmit the OTP to the first group of electronic circuits via NFC communication.

The above aspects, variations, and options are to be understood as comprisable within the invention singly, or in combination with each other.

### BRIEF DESCRIPTION OF THE DRAWINGS

In order that the present invention can be more readily understood, reference will now be made to the accompanying drawings which illustrate preferred embodiments of the invention and wherein:

FIG. 1 illustrates a multi-scheme payment system according to the present invention;

FIGS. 2A and 2B illustrate a digital/logical payment card, and mobile electronic device integrating a digital/logical payment card, according to a preferred embodiment of the present invention;

FIGS. 3A and 3B illustrates an operation of the mobile electronic devices according to a preferred embodiment and a second embodiment of the present invention to effect a financial transaction using the integrated digital/logical payment card;

FIG. 4 illustrates exemplary displays of the integrated digital/logical payment card in an ACTIVATE operation;

FIG. 5 is a flow chart describing an ACTIVATE operation;

FIG. 6 illustrates exemplary displays of the integrated digital/logical payment card in a DEACTIVATE operation;

FIG. 7 is a flow chart describing a DEACTIVATE operation;

FIG. 8 illustrates exemplary displays of the integrated digital/logical payment card in a remote transaction operation;

FIG. 9 is a flow chart describing a remote transaction operation using a digital/logical payment card according to the present invention;

FIG. 10 illustrates exemplary displays of the integrated digital/logical payment card in a POS/ATM transaction operation;

FIG. 11 is a flow chart describing a POS/ATM transaction operation using a digital/logical payment card according to the present invention;

FIG. 12 illustrates exemplary displays of the integrated digital/logical payment card in an NFC tap transaction operation;

FIG. 13 is a flow chart describing an NFC tap transaction operation using a digital/logical payment card according to the present invention; and

FIGS. 14A and 14B illustrate a digital/logical payment card, and mobile electronic device integrating a digital/logical payment card, according to a second embodiment of the present invention.

### DETAILED DESCRIPTION OF PREFERRED EMBODIMENTS

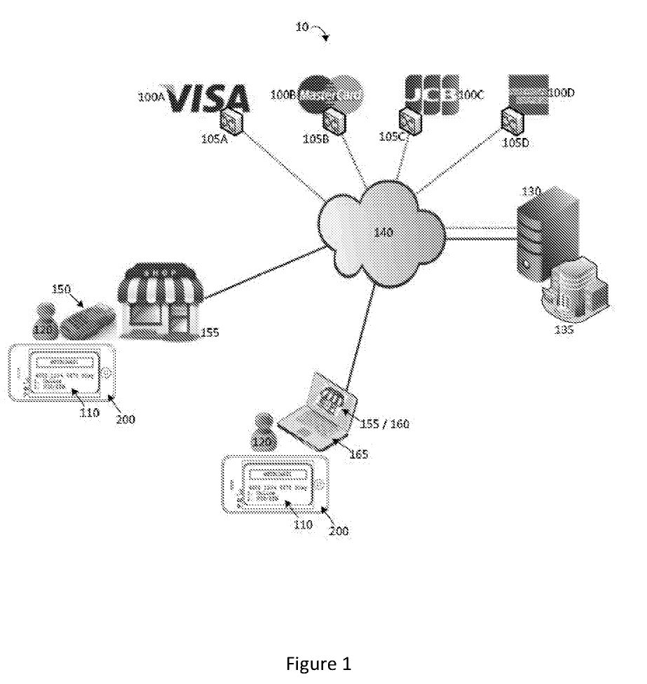

With reference to FIG. 1, a multi-scheme payment system 10 according to a first aspect of the present invention is described.

The multi-scheme payment system 10 is a system for facilitating electronic transactions, such as credit and debit card payments, loyalty/reward point credit and debit, and the like. The system 10 allows users 120 to make electronic transactions using any one of a number of payment schemes 100A, 100B, 100C, 100D with which the users 120 have accounts. The payment schemes 100A, 100B, 100C, 100D can include, for example, credit payment schemes such as Visa™′ MasterCard™, and American Express™, and can also include store cards/schemes (e.g. David Jones™, Walmart™) and loyalty/reward cards/schemes (e.g. Virgin™, Qantas™), or a combination of such and other similar schemes. For purposes of this description, and without limiting the scope of this invention, the payment schemes 100A-D will hereinafter be described as credit payment schemes. The electronic transactions are effected from a single mobile electronic device integrated with a digital/logical payment card 110, regardless of the payment scheme 100A-D used.

The system 10 includes a wallet server 130 connected to a network 140. The wallet server 130 is managed by a wallet provider 135 and stores therein a wallet account for each user 120. Each user's wallet account stores details for each payment scheme 100A-D that the user 120 has an account with. In one form, each user wallet account stores one or more of the name, primary account number, card type, expiry date, and card code verification number (e.g. CCV2), for one or more credit or debit cards (e.g. cards corresponding to each of payment schemes 100A-D) that the user 120 owns.

A point-of-sale (POS) device 150 belonging to a vendor 155 and/or an online transaction portal 160 accessible via an electronic device 165 are connected to the wallet server 130 via the network 140. The POS device 150 is preferably an NFC (Near Field Communication) enabled device, and accordingly operable to read the digital/logical payment card 110 via NFC communication (e.g. VISA™ PayWave™) Also connected to the wallet server 130 via the network 140 are financial systems 105A, 105B, 105C, 105D for the one or more payment schemes 100A-D supported by the wallet server 130.

The digital/logical payment card 110 is in all essential respects similar to a payment integrated circuit (IC) card conforming to the ISO7816 standard. The digital/logical payment card 110 however is integrated into a mobile electronic device 200 such as a smartphone, tablet, smartwatch, electronic bracelet, and the like, rather than embodied as a physical card. The digital/logical payment card 110, other than in terms of physical dimensions and properties, conforms to a payment IC card standard. In one form, the digital/logical payment card 110 conforms to the EMV (Europay™, Mastercard™, and Visa™) smartcard payment standard. Accordingly, the digital/logical payment card 110 is accepted at any terminal, machine, and/or vendor that is registered appropriately for EMV transactions. In another form, the digital/logical payment card 110 can conform to the PBOC (People's Bank of China) payment standard.

As will be described in greater detail below, the digital/logical payment card 110 is issued with one or more primary account numbers (PANs) from the one payment standard (in one embodiment, from the EMV payment standard). Each PAN is stored in correspondence with a selectable preset. The PANs identify to the wallet server 130 a payment scheme 100A-D desired to be used by the user 120 to perform a transaction. The PANs stored in the digital/logical payment card 110 are communicated to the wallet server 130 by way of, for example, the POS device 150 by NFC communication, manual input, or other wired or wireless communication. The user 120 can also provide the PANs through the transaction portal 160, or by any other form of communication including telephone, other verbal or written form, and the like.

As will be described in greater detail below, a financial transaction between the user 120 and the vendor 155 is realized by the user 120 operating the mobile electronic device 200 and hence digital/logical payment card 110 to indicate which payment scheme the user 120 desires to conduct the transaction with. A PAN corresponding to a preset activated for the desired payment scheme is sent to the wallet server 130, for example via the POS device 150 or the transaction portal 160. The wallet server 130, upon receiving the PAN, determines which of the payment schemes 100A-D the user 120 desires to conduct the transaction with. Once the desired payment scheme is identified, the wallet server 130 retrieves the actual user details for the desired payment scheme from the user's wallet account. In an exemplary case where the user 120 desires to transact via the VISA™ payment scheme, for example, the user's VISA™ primary account number, VISA™ card expiry date, and the like are retrieved from the user's wallet account. These details are then transmitted by the wallet server 130 to the financial systems 105A of the VISA™ payment scheme 100A.

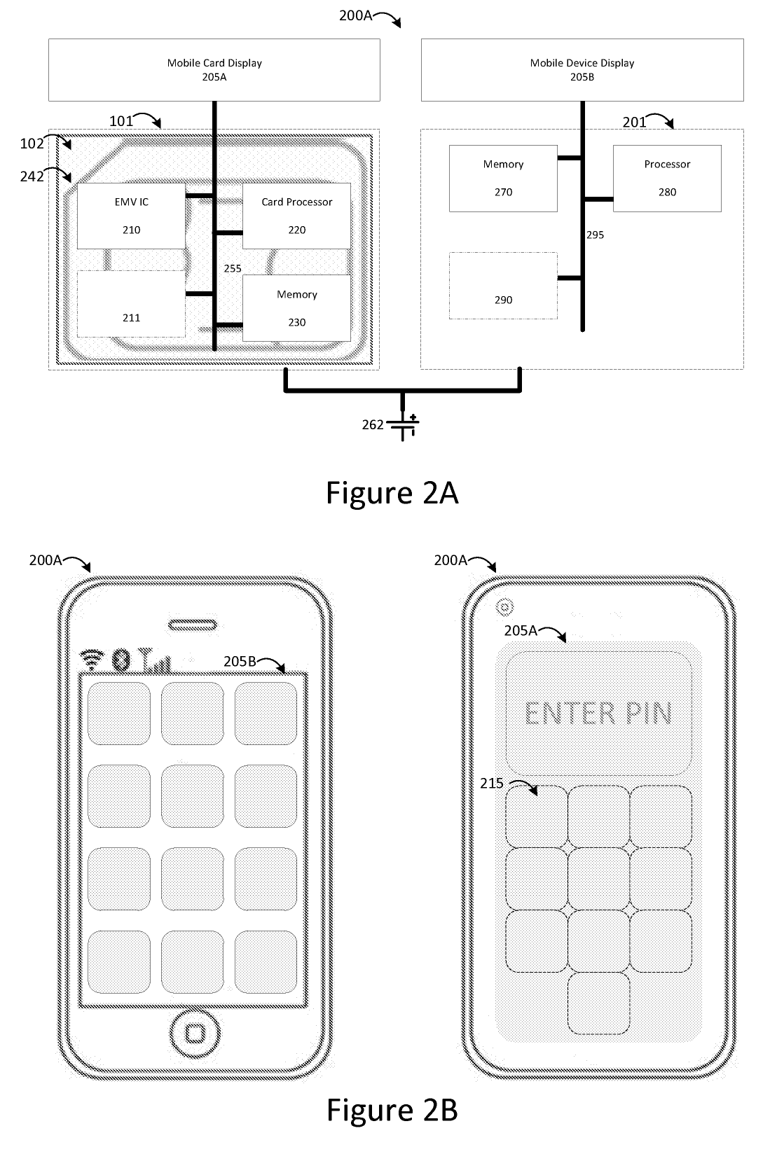

With reference now to FIGS. 2A and 2B, a preferred embodiment of the digital/logical payment card 110 and a mobile electronic device 200A integrating the digital/logical payment card 110 are described in detail.

As schematically illustrated in FIG. 2A, the mobile electronic device 200A includes a payment card circuit 101 and a mobile device circuit 201. The payment card circuit 101 contains the electronic hardware for realizing the digital/logical payment card 110, while the mobile device circuit 201 contains the electronic hardware for realizing the normal functions of the mobile electronic device 200A. The payment card circuit 101 and the mobile device circuit 201 are communicatively isolated from each other in that data transfer between the two circuits is not permitted.

The payment card circuit 101 comprises an EMV Integrated Circuit (IC) 210. The digital/logical payment card 110 can also include other electronic circuits as necessary to improve the function of the digital/logical payment card 110, including for example a card processor 220, and a memory 230, and other further electronic circuits such as a Near Field Communications (NFC) transceiver, dedicated display adapter, and the like. These other further electronic circuits are illustrated collectively by reference number 211 in FIG. 2A. The electronic circuits 210, 220, 230, 211 are interconnected via a bus 255.

According to the preferred embodiment, the electronic circuits 210, 220, 230, 211 making up the payment card circuit 101 are physically embodied as a dockable chip 242, for example a ISO/IEC 7810:2003, ID-000 form factor card. The dockable chip 242 is removably received into a dock 102 of the mobile device 200A to integrate and connect to other hardware on the mobile device 200A, such as a mobile card display 205A, and a power source 262. In order embodiments, the chip 242 can instead be hardwired to or otherwise irremovable from the mobile device 200A and its other hardware.

The EMV IC 210 of the payment card circuit 101 is an integrated circuit configured according to the EMV standard to transact financial transaction. The EMV IC 210 is adapted to provide wired and/or wireless communication with an appropriate EMV terminal, such as a point-of-sale (POS) terminal.

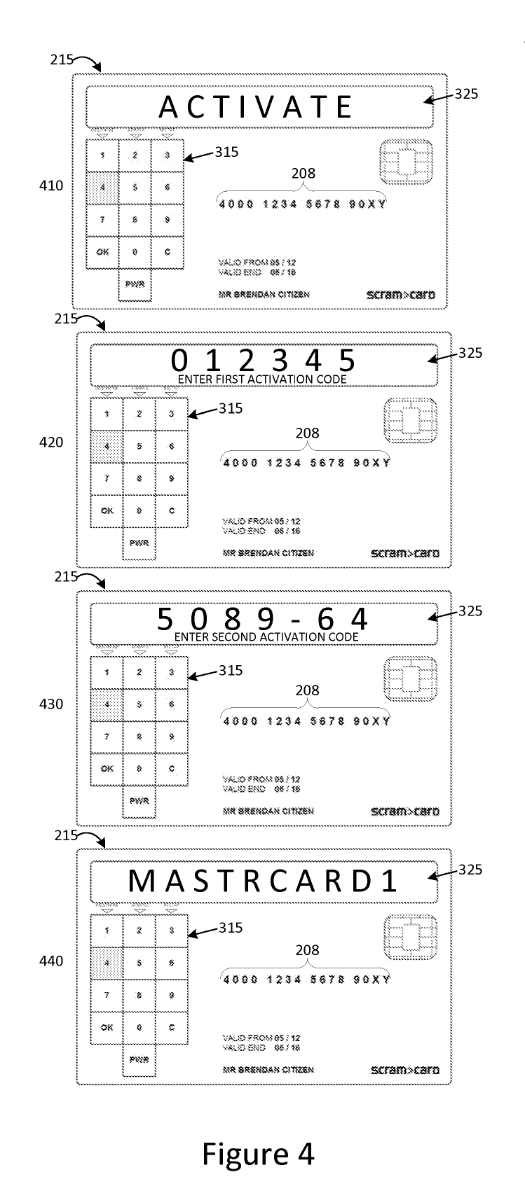

The card processor 220 is a processing unit configured to control and coordinate the operation of the mobile electronic device 200A when the mobile electronic device 200A is operating in a card-operation mode. The card processor 220 is, in particular, configured to execute one or more instructions to allow a user to interact with the mobile electronic device 220, including receiving user inputs, controlling a display 205, accessing the memory 230, executing pre-stored applications and code, and the like. Additionally, the card processor 220 is configured to execute the processes illustrated in FIGS. 4 to 13, and described in greater detail below. In one form, the card processor 220 can be included in the EMV IC 220.

The memory 230 is a storage area for storing data necessary to effect a financial transaction. The memory 230 stores, for example, code representing one or more processes or applications to be executed by the card processor 220, and/or is used as a working memory. The memory 230 can further store primary account numbers (PAN), card code verification numbers (CCV2), and other card or account related information. The memory 230 can be volatile memory, non-volatile memory, or a combination of volatile and non-volatile memory.

As aforementioned, the mobile device circuit 201 includes the electronic hardware for realizing the normal functions of the mobile device 200A. Such electronic hardware can include, for example, a device memory 270, device processor 280, device bus 295, and other device circuitries 290 such as an NFC transceiver. Hereinafter, the mobile device circuit 201 is interchangeable referred to also as the mobile electronic device proper 201.

The mobile electronic device 200A of the preferred embodiment further includes a mobile card display 205A and a mobile device display 205B. The mobile card display 205A in the preferred embodiment is electronically connected to the dock 102, and thereby to the dockable chip 242 and electronic circuits 210, 220, 230, 211 In embodiments where the chip 242 is instead hardware to or otherwise irremovable from the mobile electronic device 200A, the mobile card display 205A is electronically connected to the chip 242 by one or more busses. The mobile device display 205B is electronically connected to the mobile device circuit 201. In the preferred embodiment, both the mobile card display 205A and the mobile device display 205B are touchscreen displays. Preferably, the mobile card display 205A is a low energy and low resolution display such that a dedicated graphics processor is not required in the payment card circuit 101 (or only a smaller, energy un-intensive graphics processor is required).

As illustrated in FIG. 2B, in the preferred embodiment the mobile card display 205A is an e-Ink display provided on a rear surface of the mobile electronic device 200A. It is to be understood, however, that the invention is not so limited and that the mobile card display 205A can be of another type, and provided in other locations, depending for example on the size, shape, and function of the mobile electronic device 200. The mobile card display 205A can, for example, be displayed remotely from the mobile electronic device 200A, such as on a second mobile electronic device (e.g. smartwatch) connected to the mobile electronic device 200A.

When accessed and controlled by the electronic circuits 210, 220, 230, 211 of the payment card circuit 101 the display 205B is operable to display a card-operation interface 215 (FIG. 2B) for facilitating interaction with and operation of the digital/logical payment card 110.

Preferably, a common power source 262 is provided to power both the payment card circuit 101 and the mobile device circuit 201m. However, separate power sources can also be provided, each dedicated to respectively power the payment card circuit 101 and the mobile device circuit 201.

The mobile electronic device 200A is operable in two modes, namely a device-operation mode and a card-operation mode. The mobile electronic device 200A of the preferred embodiment may be simultaneously operated in both modes. For security reasons, however, it can be preferable to only allow one mode at a time to operate, thereby ameliorating the risk of one mode interfering (whether unintentionally or intentionally) with the other.

The arrangement of the electronic circuits 210, 220, 230, 211 of the payment card circuit 101 and the electronic circuits 270, 280, 290, of the mobile electronic device proper 201 according to the preferred embodiment allows the payment card circuit 101 and hence the digital/logical payment card 110 embodied thereby to be physically separated/isolated from the mobile device circuit 201, whereby both the digital/logical payment card 110 and the mobile electronic device 200 can be operated independently of the other.

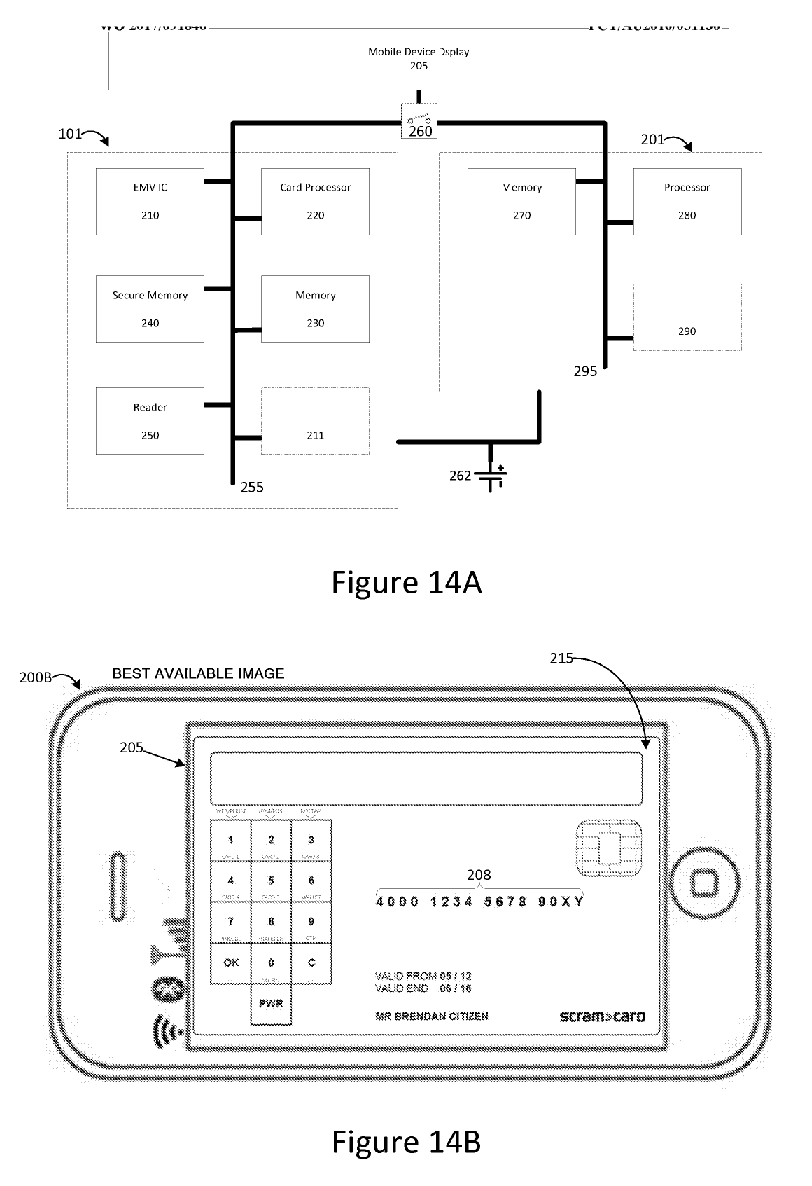

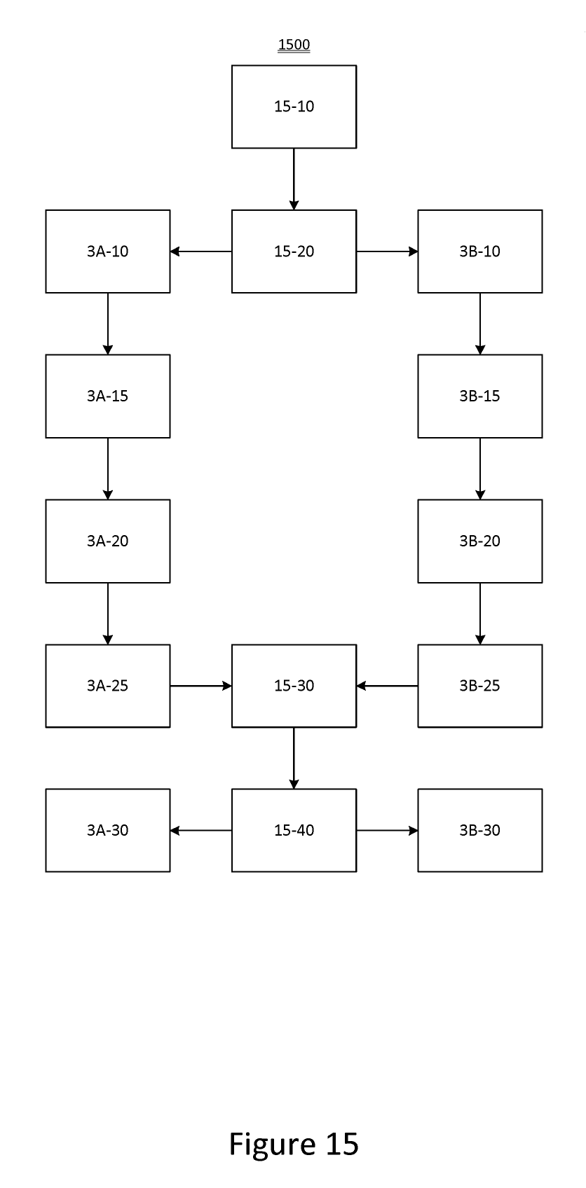

With reference now to FIGS. 14A and 14B, a second embodiment of the digital/logical payment card 110 and a mobile electronic device 200B integrating the digital/logical payment card 110 are described. In FIGS. 14A and 14B, elements with the same or similar function to those in the preferred embodiment of FIGS. 2A and 2B are given the same reference numerals.

As schematically illustrated in FIG. 14A, the mobile electronic device 200B of the second embodiment includes a payment card circuit 101 and a mobile electronic circuit 201, similar to the preferred embodiment. The payment card circuit 101 contains the electronic hardware for realizing the digital/logical payment card 110, while the mobile device circuit 201 contains the electronic hardware for realizing the normal functions of the mobile device 200B. The payment card circuit 101 and the mobile device circuit 201 are communicatively isolated from each other in that data transfer between the two circuits is not permitted.

The payment card circuit 101 comprises an EMV Integrated Circuit (IC) 210. The payment card circuit 101 can also include other electronic circuits as necessary to improve the function of the digital/logical payment card 110, including for example a card processor 220, a secure memory 230, a general card memory 240, and a card reader 250, and other further electronic circuits such as a Near Field Communications (NFC) transceiver, dedicated display adapter, and the like. These other further electronic circuits are illustrated collectively by reference number 211 in FIG. 14A. The electronic circuits 210, 220, 230, 240, 250, 211 are interconnected via a bus 255.

As with the preferred embodiment, the EMV IC 210 of the second embodiment is an integrated circuit configured according to the EMV standard to transact financial transaction. The EMV IC 210 is adapted to provide wired and/or wireless communication with an appropriate EMV terminal, such as a point-of-sale (POS) terminal.

As with the preferred embodiment, the card processor 220 is a processing unit configured to control and coordinate the operation of the mobile electronic device when the mobile electronic device is operating in a card-operation mode. The card processor 220 is, in particular, configured to execute one or more instructions to allow a user to interact with the mobile electronic device 220, including receiving user inputs, controlling a display 205, accessing the general memory 240, executing pre-stored applications and code, and the like. Additionally, the card processor 220 is configured to execute the processes illustrated in FIGS. 4 to 13, and described in greater detail below. In one form, the processor 220 can be included in the EMV IC 210.

The secure memory 230 is a storage area for storing secured data necessary to effect a financial transaction. The secure memory 230 stores, for example, primary account numbers (PAN), card code verification numbers (CCV2), and other card or account related information. The secure memory 230 can be volatile memory, non-volatile memory, or a combination of volatile and non-volatile memory.

The general card memory 240 is a storage area for storing non-secured data, including code representing one or more processes or applications to be executed by the card processor 220. The general memory 240 can also be configured for use as a working memory for the general memory 240. The general memory 240 can be volatile memory, a non-volatile memory, or include a combination of volatile and non-volatile memories.

The card reader 250 functions as an input means for receiving user account details. The user account details receivable by the card reader 250 include account name(s), account number(s), expiry date(s), CCV2 number(s), personal identification number(s) (PIN), and the like. By using the card reader 250, different and multiple digital/logical payment cards (for example, ISO/IEC 7810:2003, ID-000 format cards) can be loaded (permanently or temporarily) into the mobile electronic device 200 for use in financial transactions.

The electronic circuits 210, 220, 230, 240, 250, 211 of the digital/logical payment card 110 are integrated with the other electronic circuits of the mobile device circuit 201, for example the device memory 270, the device processor 280, device bus 295, and other device circuits 290.

According to the second embodiment, the electronic circuits 210, 220, 230, 240, 250, 211 of the payment card circuit 101 and the electronic circuits 270, 280, 290 of the mobile device circuit 201 are isolated from each other by a switch 260. The switch 260 is toggle-able by the user, and switches the mobile electronic device 200B between a card-operation mode and a device-operation mode.

In the device-operation mode, the electronic circuits 210, 220, 230, 240, 250, 211 are inaccessible and/or otherwise inoperative. In one embodiment, the electronic circuits 210, 220, 230, 240, 250, 211 enter a hibernation state when the switch 260 is switched the device-operation mode. In the hibernation state, the last known state of the electronic circuits 210, 220, 230, 240, 250, 211 is saved, for example in the general card memory 240 and/or the secure memory 230. This allows the last known state (if any) to be reproduced exactly if and when the mobile electronic device 200B is switched back to a card-operation mode. In a preferred embodiment, however, the electronic circuits 210, 220, 230, 240, 250, 211 can still be operating at full or some capacity but no outputs (for example to the display 205) or inputs (for example from the user 120 via the display/touchscreen 205) to/from these electronic circuits 210, 220, 230, 240, 250, 211 are permitted.

While in the device-operation mode, the mobile electronic device 200B operates exactly as it normally would. That is, if the mobile electronic device 200B is a smartphone, the mobile electronic device 200B operates exactly as a typical smartphone operates.

In the card-operation mode, the electronic circuits 270, 280, 290 are inaccessible and otherwise inoperative. In one embodiment, the electronic circuits 270, 280, 290 are in a hibernation state. In the hibernation state, the last known state of the electronic circuits 270, 280, 290 is saved, for example in the device memory 270. This allows the last known state (if any) to be reproduced exactly if and when the mobile electronic device 200B is switched back to a device-operation mode. In a second embodiment, the electronic circuits 270, 280, 290 can still be operating at full or some capacity but no outputs (for example to the display 205) or inputs (for example from the user 120 via the display/touchscreen 205) to/from these electronic circuits 270, 280, 290 are permitted.

In the card-operation mode, the mobile electronic device 200B operates as a payment card such as a credit card or debit card. Greater details of the operations and functionalities of the mobile electronic device 200B when operating in the card-operation mode are described below.

In the second embodiment, the mobile electronic device 200B has a shared display and/or touchscreen 205. The display 205 is accessible by both the electronic circuits 210, 220, 230, 240, 250, 211 of the digital/logical payment card 110 and the electronic circuits 270, 280, 290 of the mobile electronic device proper 201.

When accessed and controlled by the electronic circuits 210, 220, 230, 240, 250 of the digital/logical payment card 110, the display 205 is operable to display a card-operation interface 215 (FIG. 14B) for facilitating interaction with the digital/logical payment card 110. In the example shown in FIG. 14B, the card-operation interface 215 is illustrated as a virtual card. It is to be understood that the card-operation interface 215 is not so limited, and can be displayed as any appropriate visual and/or audio interface. Typically, the card-operation interface 215 will be designed to best suit the type of the mobile electronic device 200B (e.g. smartphone, tablet, watch, etc.).

The above described arrangement of the electronic circuits 210, 220, 230, 240, 250, 211 of the digital/logical payment card 110 and the electronic circuits 270, 280, 29 of the mobile electronic device proper 201 means that the digital/logical payment card 110 can be separated/isolated from the mobile electronic device 200B, whereby both the digital/logical payment card 110 and the mobile electronic device 200B can be operated independently of the other despite potentially sharing some common hardware such as the display 205. The switch 260 ensures that data cannot cross between the digital/logical payment card 110 and the mobile electronic device proper 201.

In the above description of the mobile electronic device 200B, the payment card circuit 101 are described as physically separate from the electronic circuits 270, 280, 290, 295 of the mobile device circuit 201. The mobile electronic device 200B of the second embodiment is not, however, so limited. Through the use of virtual machines and the like, one or more of the electronic circuits 210, 220, 230, 240, 250, 255, and 211 of the payment card circuit 101 can be the same physical electronic circuit as one or more of the electronic circuits 270, 280, 290, 295 of the mobile device circuit 201, but separated and isolated logically/digitally by the virtual machine architecture. For example, card processor 220 and device processor 280 can be the same physical microprocessor chip, but logically separated and isolated by the virtual machine architecture. Similarly, the card memory 240 and device memory 270 can also be the same physical RAM or ROM chip, but logically separated and isolated by the virtual machine architecture.

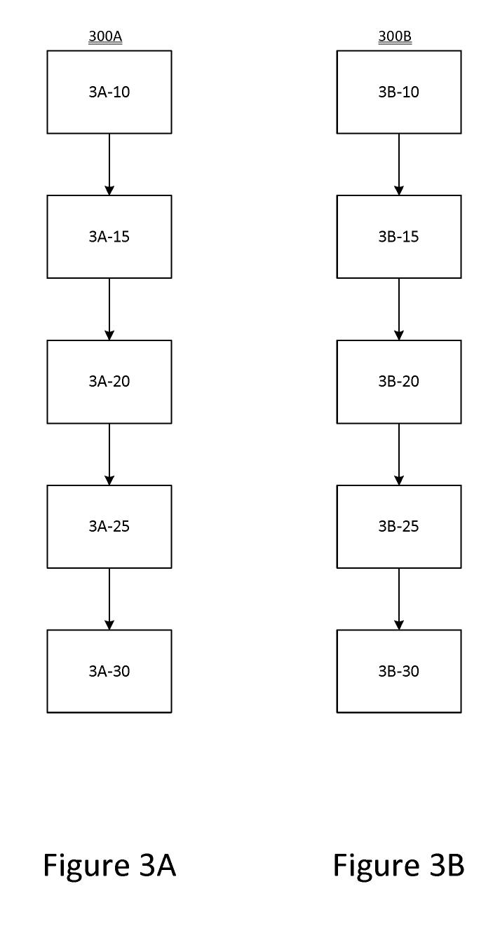

With reference now to FIG. 3A, an exemplary general operation 300A to effect a financial transaction using the mobile electronic device 200A according to the preferred embodiment is described.

For the purposes of description, it is assumed that the mobile electronic device 200A of the preferred embodiment is currently in a device-operation mode, where it is operating in accordance with its intended design. For example, assuming the mobile electronic device 200A is a smartphone, it is assumed that the mobile electronic device 200 is operating as a smartphone and allowing the user 120 to perform all the usual functions of a smartphone.

The general operation 300A commences at 3A-10, where/when the user 120 desires to perform a financial transaction. The financial transaction could, for example, be conducted in person with the user 120 presenting the digital/logical payment card 110 to a POS terminal 150, or could be a remote transaction where the user 120 is providing his/her card details over a phone or internet portal 160.

At 3A-10, the user 120 toggles the mobile electronic device 200A to operate in the card-operation mode. When the mobile electronic device 200A is operating in the card-operation mode, inputs and outputs to/from the electronic circuits 270, 280, 290 can be disconnected if the mobile electronic device 200A has been configured to only operate in one mode at a time. Similarly, if the mobile electronic device 200A has been configured to only operate in one mode at a time, inputs and outputs such as the display 205A are connected to the electronic circuits 210, 220, 230, 211 of the payment card circuit 101.

At 3A-15, the electronic circuits 210, 220, 230, and 211 are powered/booted up if they are not already. Included in this step is the process of loading any operating system, drivers, and other software necessary for the digital/logical payment card 110 to function.

At 3A-20, the user interface 215 specific to the card-operation mode is displayed on the mobile card display 205A of the mobile electronic device 200A.

At 3A-25, by way of the card-operation interface 215, the user 120 operates the digital/logical payment card 110 as required to authorize execution of the financial transaction. The various processes for operating the digital/logical payment card 110 are described in greater detail below with reference to FIGS. 4 to 13.

At 3A-30, once the financial transaction is complete, the user 120 toggles the mobile electronic device 200A back to the device-operation mode. Upon entering the device-operation mode, if the mobile electronic device 100A is configured to operate in a single mode only, the electronic circuits 210, 220, 230, 211 of the payment card circuit 101 are disconnected from inputs and outputs such as the display 205A. At the same time, the electronic circuits 270, 280, 290 of the mobile electronic device proper 201 are reconnected to appropriate inputs and outputs, such as the display 205B. The user 120 can then continue normal operation of the mobile electronic device 200A.

It will be understood that if the mobile electronic device 200A is configured to allow simultaneous operation in both the card-operation mode and device-operation mode, the above steps to toggle between the two modes, including those to ensure that the right circuits are connected/disconnected from inputs and outputs, are not required.

Next, with reference to FIG. 3B, an exemplary general operation 300B to effect a financial transaction using the mobile electronic device 200B according to the second embodiment is described.

For the purposes of description, it is assumed that the mobile electronic device 200B is currently in a device-operation mode, where it is operating in accordance with its intended design. For example, assuming the mobile electronic device 200B is a smartphone, it is assumed that the mobile electronic device 200B is operating as a smartphone and allowing the user 120 to perform all the usual functions of a smartphone.

The general operation 300B commences at 3B-10, where/when the user 120 desires to perform a financial transaction. The financial transaction could, for example, be conducted in person with the user 120 presenting the digital/logical payment card 110 to a POS terminal 150, or could be a remote transaction where the user 120 is providing his/her card details over a phone or internet portal 160.

At 3B-10, the user 120 toggles the switch 260 to switch the mobile electronic device 200B from the device-operation mode to the card-operation mode. When the mobile electronic device 200B is switched to the card-operation mode, inputs and outputs from the electronic circuits 270, 280, 290, 295 of the mobile device circuit 201 to/from the display 205 are disconnected. At the same time, inputs and outputs to/from the display 205 are connected to the electronic circuits 210, 220, 230, 240, 250, 255, 211 of the payment card circuit 101.

At 3B-15, the electronic circuits 210, 220, 230, 240, 250, 211 are powered/booted up if they are not already. Included in this step is the process of loading any operating system, drivers, and other software necessary for the digital/logical payment card 110 to function.

At 3B-20, the user interface 215 specific to the card-operation mode is displayed on the display 205 of the mobile electronic device 200B.

At 3B-25, by way of the card-operation interface 215, the user 120 operates the digital/logical payment card 110 as required to authorize execution of the financial transaction. The various processes for operating the digital/logical payment card 110 are described in greater detail below with reference to FIGS. 4 to 13.

At 3B-30, once the financial transaction is complete, the user 120 switches the switch 260 back to the device-operation mode. Upon switching back to the device-operation mode, the electronic circuits 210, 220, 230, 240, 250, 211 of the payment card circuit 101 are disconnected from inputs and outputs of the display 205, which inputs/outputs are then reconnected back to the electronic circuits 270, 280, 290, 295 of the mobile electronic device proper 201. The user 120 can then continue normal operation of the mobile electronic device 200B.

The mobile electronic devices 200A, 200B and the operations 300A, 300B, allow operations and processes specific to the running of the mobile electronic devices 200A, 200B to be separated and isolated from the operations and processes specific to the execution of a financial transaction. Transfer of data and information, whether intentional or unintentional, between the card-operation mode and the device-operation mode is prevented, or at least ameliorated. In this manner, malicious or accidental compromise of the user's digital/logical payment card 110 is prevented.

With reference to FIG. 15, a specific operation 1500 to effect a financial transaction using either of the mobile electronic devices 200A or 200B is described. The specific operation 1500 is one where a financial transaction is being transacted using a mobile application executing on the mobile electronic devices 200A, 200B.

The mobile application being executed on the mobile electronic devices 200A, 200B is one that is configured to facilitate and accept payment from smartcard payment cards, such as the digital/logical payment card 110, over NFC. The mobile application in being executed on the mobile electronic devices 200A, 200B, in effect cause the mobile electronic devices 200A, 200B to function as a POS device 150.

The specific operation 1500 commences at 15-10, where the mobile application is operated to facilitate a purchase. The mobile application can itself facilitate the process to search, identify, and subsequently transact payment for the good or service for purchase, or can simply facilitate the process to transact payment for the good or service for purchase.

At 15-20, the mobile application presents a prompt requesting for payment information to be entered into the mobile application. The payment information can include, for example, a primary account number, a PIN or other passcode, and the like.

Next, either the general operation 300A or the general operation 300B is commenced. As required, steps 3A-10 to 3A-25 or 3B-10 to 3B-25 are conducted. Upon completion of step 3A-25 or step 3B-25, a one-time pin (OTP) is generated by the digital/logical payment card 110. The OTP, for the purposes of the specific operation 1500, is one of the pieces of payment information required by the mobile application to continue its transaction.

At 15-30, the digital/logical payment card 110 and the mobile application are operated to transfer the OTP and other payment information including, for example, a primary account number, via NFC from the digital/logical payment card 110 to the mobile application. This operation can be a manual process, involving the user 120 priming the mobile application to receive the payment information and further operating the digital/logical payment card 110 to send the payment information. The operation can also be a fully or partially automated process, which, on one extreme, requires no effort from the user 120 beyond operating the digital/logical payment card 110 to generate the OTP, and on another extreme, requires effort from the user 120 to operate either the mobile application to receive the payment information, or operate the digital/logical payment card 110 to send the payment information.

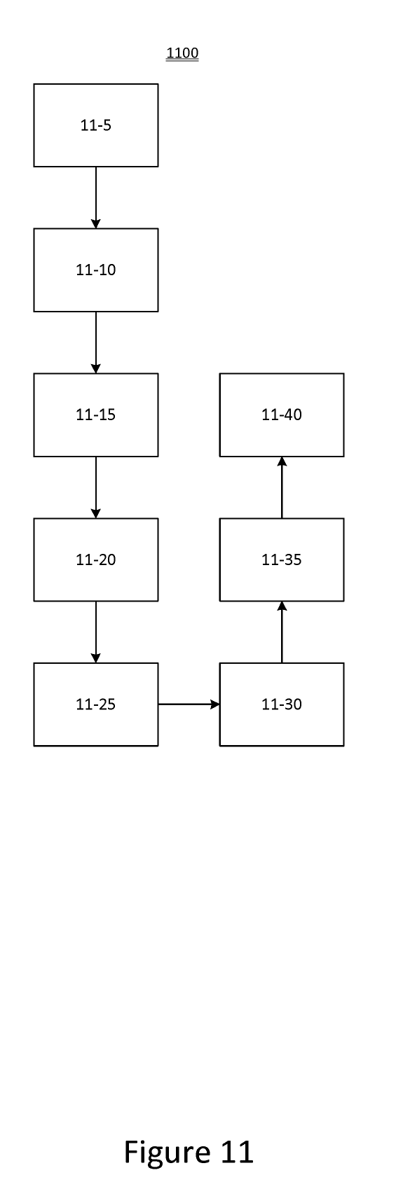

At 15-40, the mobile application receives the payment information via NFC from the digital/logical payment card 110 and using the payment information, conducts the transaction. The transaction can be conducted for example in similar manner to that of the operation 1100 described in greater detail below with reference to FIG. 11.

Following 15-40, step 3A-30 or 3B-30 is conducted as per operations 300A, 300B.

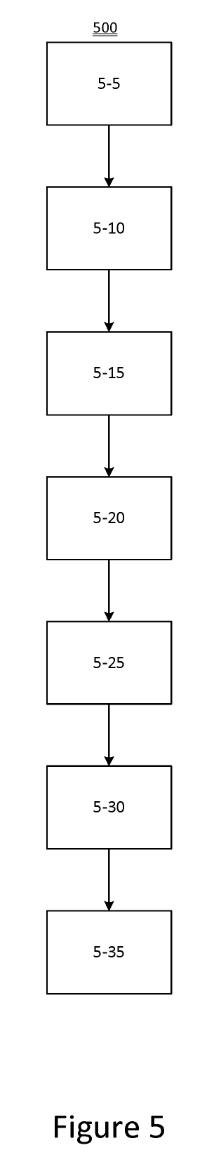

With reference now to FIGS. 4 and 5, an activation operation 500 of the digital/logical payment card 110 to activate a preset of the digital/logical payment card 110 for a payment scheme account is described. The activation operation 500 is performed typically in tandem with an online or telephone based operation in which the user 120 indicates to the wallet server 130 which of the user's payment scheme accounts should be associated with which presets of the digital/logical payment card 110.

For ease of description, the following operation 500 is described in relation to an example where the user 120 has indicated to the web server 130 that they desire to activate preset ‘4’ on their digital/logical payment card 110 for use with their Mastercard™ account. It should be understood that the following operation 500 is applicable regardless of which presets of the digital/logical payment card 110 is desired to be activated, and regardless of which payment scheme the presets is to be activated for.

The operation 500 to activate preset ‘4’ of the digital/logical payment card 110 for use with the user's Mastercard™ payment scheme account commences at 5-5 in the flow chart of FIG. 5, where the user 120 toggles the mobile electronic device 200A, 200B containing the digital/logical payment card 110 to operate in the card-operation mode.

In the card-operation mode, input/output can be limited to and from only the electronic circuits of the payment card circuit 101, for example if the mobile electronic device 200A has been configured to only allow operation in one mode at a time, or if the operation 500 is being executed on the mobile electronic device 200B.

Upon the user 120 toggling the mobile electronic device 200A, 200B to operate in the card-operation mode, the display 205A, 205 of the mobile electronic device 200A, 200B displays the card-operation interface 215. For purposes of illustration and description, the card operation interface is depicted in the accompanying drawings as a replica of a physical card. It is to be understood however that the user interface can be displayed in any graphical form on the display, so long as appropriate input means (whether touch, voice, or otherwise) are provided to facilitate input from the user 120.

The user interface 215 is displayed on the mobile card display 205A (in the case where the operation 500 is executed on the mobile electronic device 200A) or on the shared mobile device display 205 (in the case where the operation 500 is executed on the mobile electronic device 200B).

Next, at 5-10, after or in tandem with the user 120 performing the aforementioned tandem operation to indicate to the wallet server 130 that a activation operation is desired, the user 120 selects preset ‘4’ on the card-operation interface 215 to commence the operation 500. In the exemplary interface illustrated in the present figures, the user 120 presses ‘4’ on the virtual keypad 315 of the card-operation interface 215.

At 5-15, the display 205A, 205 displays a suitable message to inform the user 120 that they have commenced an activation operation. The display 205A, 205 can, for example, display the word “ACTIVATE” on the virtual screen 325 of the card-operation interface 215 (see screen 410 of FIG. 4) to indicate to the user that preset ‘4’ is available as a suitable candidate for activation.

At 5-20, a screen 420 (FIG. 4) prompts the user 120 to enter in a first activation code. The first activation code is provided to the user 120 by the wallet server 130 during the aforementioned tandem operation, and is specific to preset ‘4’. The first activation code is entered into the digital/logical payment card 110 by the user 120 by way of the card-operation interface 215, for example by way of the virtual keypad 315. The screen 420 (FIG. 4) is operable to display the digits as they are entered by the user 120 via the keypad 315. The activation code validates the user's authority to activate preset ‘4’ of the digital/logical payment card 110. The requirement for a first activation code prevents erroneous and/or unauthorized activation of the presets. Specifically, the correct first authorization code is only known to the person who performed the aforementioned tandem operation with the wallet server 130, or an authorized delegate of that person.

At 5-25, the card processor 220 checks if the code entered by the user is valid. If the code is determined to be invalid, the activation operation 500 is concluded. If the code is determined to be valid, the operation proceeds to 5-30.

At 5-30, the display 205A, 205 of the mobile electronic device 200A, 200B displays a screen 430 (FIG. 4) to prompt the user 120 to enter a second activation code. The second activation code is also provided to the user by the wallet server 130 during the aforementioned tandem operation. The second activation code acts as a further check against erroneous and/or unauthorized preset programming. The second activation code is entered by the user 120 by way of the virtual keypad 315. In one form, the second activation code is comprised of two parts. A first part of the code includes the activation sequence. A second part of the code identifies to the digital/logical payment card 110 the payment scheme (e.g. Mastercard™ Visa™, AMEX™) that the preset is being activated for. In the example illustrated in the screen 430 of FIG. 4, the second activation code is a 6 digit number where the first four digits are an activation sequence generated by the wallet server 130, and the last two digits indicate to the digital/logical payment card 110 the type of payment scheme being linked to the preset.

At 5-35, the card processor 220 checks if the code entered by the user 120 is valid for preset ‘4’, and if so, activates preset ‘4’ for use with the user's Mastercard™ account. The digital/logical payment card 110 further associates a display name to be displayed on the card-operation interface 215 each time preset ‘4’ is now pressed. The display name to be displayed is based on the second activation code.

Specifically, the display name is determined from the second part of the second activation code. An exemplary mapping of the second part of the second activation code to various payment schemes can be as follows:

| | Last 2 Digits | | | | | | | | |
|---|---|---|---|---|---|---|---|---|---|
| | 06 | 16 | 23 | 45 | 57 | 64 | 79 | 85 | 91 |
| Payment | Maestro | JCB | Electron | VISA | VISA | Mastercard | AMEX | Diners | UnionPay |
| Scheme | | | | DR | CR | | | | |

Accordingly, any second activation code ending in “64” would be identified by the digital/logical payment card 110 as a Mastercard™ account, and an appropriate display name of, for example “MASTRCARD1” is displayed on the card-operation interface 215, for example by the virtual screen 325, each time the activated preset is pressed. An exemplary screen 440 of the digital/logical payment card 110 depicting the display name is illustrated in FIG. 4. It is to be understood that the second part of the second activation code is not limited to being the last 2 digits, as in the example illustrated in FIG. 4. The second part of the second activation code can be any predetermined derivation of the second activation code.

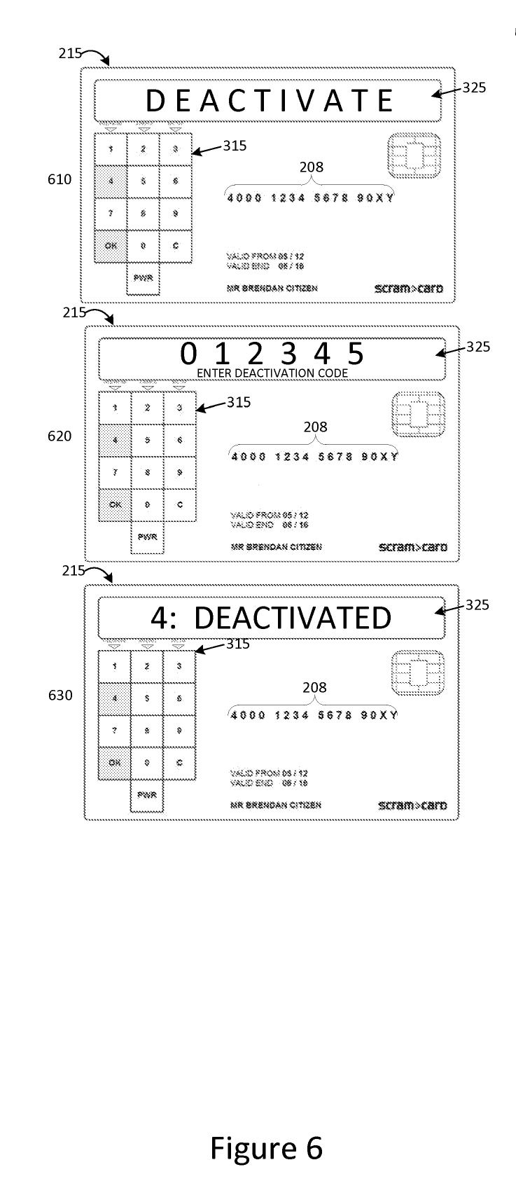

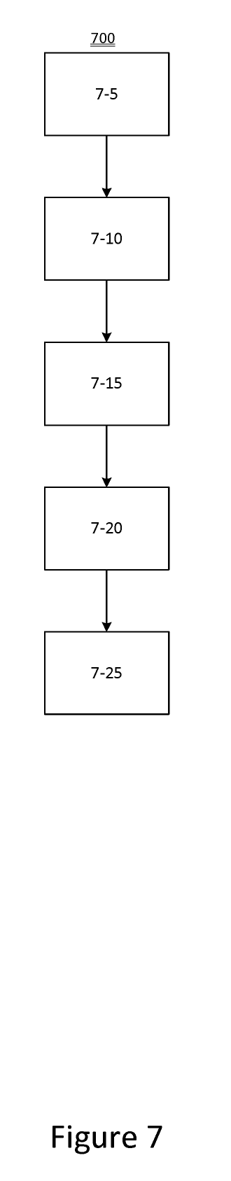

With reference now to FIGS. 6 and 7, an operation 700 for deactivating a payment scheme account from the digital/logical payment card 110 is described.

The operation 700 to deactivate a payment scheme account from the digital/logical payment card 110 commences at 7-5 in the flowchart of FIG. 7, where the user toggles the mobile electronic device 200A, 200B containing the digital/logical payment card 110 to operate in the card-operation mode.

In the card-operation mode, input/outputs can be limited only to the electronic circuits 210, 220, 230, 240, 250, 255, 211, for example if the mobile electronic device 200A has been configured to only allow operation in one mode at a time, or if the operation 500 is being executed on the mobile electronic device 200B.

Upon the user 120 toggling the mobile electronic device 200A, 200B into the card-operation mode, the display 205A, 205 of the mobile electronic device 200A, 200B displays the card-operation interface 215. For purposes of illustration and description, the card operation interface 215 is depicted in the accompanying drawings as a replica of a physical card.

Next, at 7-10 the user 120 presses a preset sequence of buttons on the virtual keypad 315. In one form, the sequence of buttons is a first press of the preset to be deactivated followed by 5 consecutive presses of the “OK” button in quick succession.

At 7-15, the virtual screen 325 of card-operation interface 215 displays a suitable message to inform the user 120 that a deactivation operation is permitted for the preset and that the digital/logical payment card 110 is ready to commence the deactivation process. In one form, the virtual screen 326 displays the word “DEACTIVATE” as illustrated in FIG. 6 with reference to screen 610.

At 7-20, the user 120 enters into the digital/logical payment card 110 a deactivation code provided to them by the wallet provider. The deactivation code is provided to the user 120 when the user 120 informs the wallet server 130 of their desire to deactivate a preset. In one form, the user 120 informs the wallet server 130 of their desire to deactivate a preset via online means, such as through a web portal, or via telephone. The deactivation code is entered by the user 120 by way of the card-operation interface 215, for example via the virtual keypad 315. A screen 620 (FIG. 6) prompts the user 120 to enter the deactivation code, and displays the digits as they are entered by the user 120. The deactivation code is specific to the preset being deactivated.

At 7-25, the card processor 220 confirms if the deactivation code entered by the user 120 is valid for the preset to be deactivated. If the code is valid, the preset is deactivated, and future presses of the preset will not result in the necessary processes for effecting a transaction. The deactivated preset is also made available for future activation for new payment scheme accounts. The display 205A, 205 displays a screen 630 (FIG. 6) to confirm to the user 120 that the preset has been delinked/deactivated.

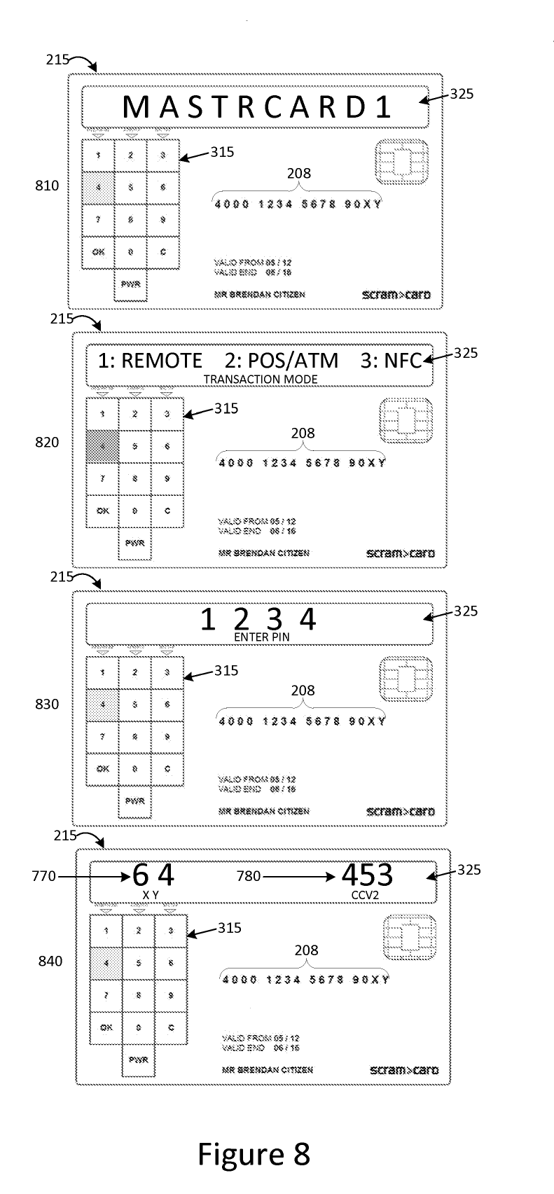

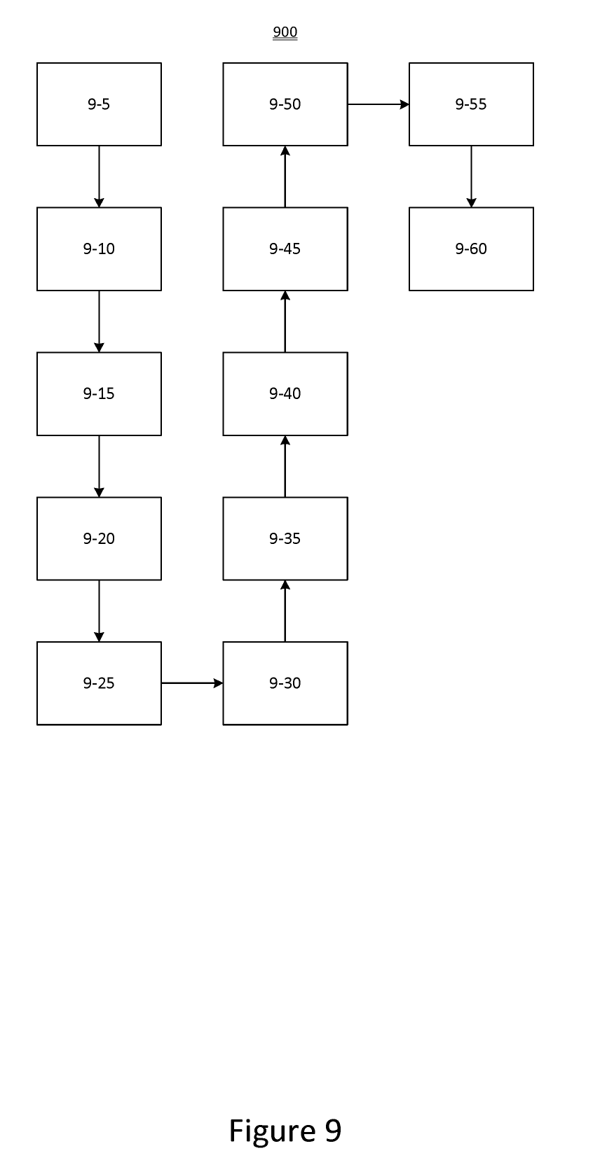

Referring to FIGS. 8 and 9, an operation 900 for making a remote transaction using the digital/logical payment card 110 is described. A remote transaction, for the purposes of this description, is one where the digital/logical payment card 110 is not physically presented to the vendor 155, such as when making an online purchase or a purchase over the telephone.

For convenience of description, it is assumed in the following description that the user 120 desires to effect payment by way of their Mastercard™ credit card which has been linked to preset ‘4’ of their digital/logical payment card 110. It is to be understood, however, that the invention is not so limited, and that the following operation 900 is applicable regardless of which payment scheme is used, and which preset of the digital/logical payment card 110 is activated.

The operation 900 commences at 9-5 in the flow chart of FIG. 9, where the user 120 toggles the mobile electronic device 200A, 200B containing the digital/logical payment card 110 to operate in the card-operation mode.

Next at 9-10, the user 120 is prompted by the vendor 155 to provide their preferred payment details. The preferred payment details are, for example, a credit card number, cardholder's name, expiry date, and the like.

At 9-15, the user 120 selects one of the payment schemes 100A-D linked to the user's digital/logical payment card 110 to effect payment. In this example, the user 120 presses preset ‘4’ using the virtual keypad 315 of the card-operation interface 215.

At 9-20, upon pressing preset ‘4’, the display 205 generates a screen 810 (FIG. 8) displaying “MASTRCARD1”, to confirm to the user 120 that preset ‘4’ corresponds to their Mastercard™ account.

At 9-25, the user 120 indicates to the digital/logical payment card 110 what kind of transaction is about to be made. Accordingly, the user 120 in this example indicates to the card that a remote transaction is to be made. This indication can be made by way of a manipulation of the virtual keypad 315 in a known sequence. In a preferred form, the button ‘1’ is pressed to indicate a remote transaction, as exemplarily illustrated by screen 820 (FIG. 8).

At 9-30, the user is subsequently presented with a screen 830 (FIG. 8) prompting the user 120 to enter in a PIN.

At 9-25, the user 120 enters in a PIN. Regardless of whether the entered PIN is valid or not, the user 120 is presented with a screen 840 (FIG. 8) displaying a card extension number 770 and a security number 780 such as a card code verification number (CCV2). The security number 780 is generated from a number of inputs, including the PIN, a random seed pre-stored in the digital/logical payment card 110, the current time, and the preset number pressed (in this case, preset ‘4’). The card extension number 770 is a static, unchanging number assigned to preset ‘4’ of the digital/logical payment card 110 and is mathematically correlated with the a card number 208. The mathematical correlation between the card extension number 770 and the card number 208, in one form, is such that when the card extension number 770 replace the variable ‘X’ and ‘Y’ digits, the resulting card number 208 satisfies a Luhn (mod 10) algorithm.

At 9-40, the PAN paired with preset ‘4’ is formed from the card number 208 with the variable digits ‘X’ and ‘Y’ replaced by the card extension number 770. The PAN paired with preset ‘4’ and the security number 780 are provided to the vendor 155/160.

At 9-45, the received PAN and the security number 780 is entered into the vendor's payment system. The payment system recognizes from the full card number that the digital/logical payment card 110 is an EMV card issued by the wallet provider 135, and accordingly provides the PAN paired to preset ‘4’, security number, amount to be debited, and other payment details to the wallet server 130 for processing.

At 9-50, the wallet server 130 receives the PAN, the security number 780, the amount to be debited, and other payment details. From the PAN, the wallet server 130 determines that preset ‘4’ was pressed by the user 120. The wallet server 130 further determines if the provided security number 780 is valid. The wallet server 130 is able to validate the security number 780 as the wallet server 130 knows which preset was pressed, the time of the transaction, the pre-stored random seed associated with the digital/logical payment card 110, and the user's PIN associated with the Mastercard™ on preset ‘4’. Accordingly, the wallet server 130 is in possession of the same information from which the security number 780 was generated, and can thereby verify the security number 780. If an incorrect PIN was entered at 9-20, the security number 780 sent to the wallet server 130 will not match the security number stored in relation to the user's Mastercard™ account for preset ‘4’.

Upon successful validation of the security number 780, the wallet server 130 retrieves the account details for the user's Mastercard™ credit card that is linked with preset ‘4’, including the actual Mastercard™ primary account number, actual expiry date, actual CCV2 number, and the like.

At 9-55, the wallet server 130 provides the user's actual Mastercard™ primary account, actual CCV2 number, actual expiry date, and other payment details to the Mastercard™ financial system 105B for processing.

At 9-60, the Mastercard™ financial system 105B receives the actual Mastercard™ primary account number, expiry date, CCV2 number, and other payment details, and verifies if the transaction should be approved. The transaction is approved or declined pursuant to the standard procedures of the financial system 105B. The approval or rejection of the transaction by the Mastercard™ financial system 105B is made known to the wallet server 130, who in turn informs the vendor/vendor's transactionportal 155/160. Accordingly, the user's transaction with the vendor 155 is correspondingly approved or declined.

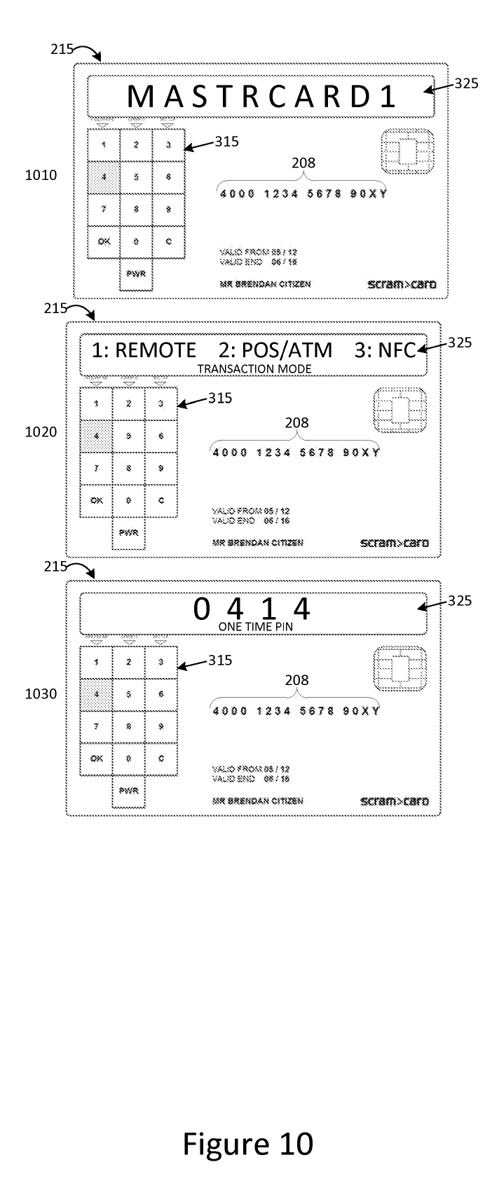

With reference to FIGS. 10 and 11, an operation 1100 for making a point-of-sale transaction using the digital/logical payment card 110 is described. A point-of-sale transaction, for the purposes of this description, is one where the digital/logical payment card 110 is physically presented to the vendor 155, such as when used with a vendor's POS device 150.

For convenience of description, it is assumed in the following description that the user 120 desires to effect transaction by way of their Mastercard™ credit card which has been linked to preset ‘4’ of their digital/logical payment card 110. It is to be understood, however, that the invention is not so limited, and that the following operation 800 is applicable regardless of which payment scheme is used, and which preset of the digital/logical payment card 110 is activated.

The operation 1100 commences at 11-5 in the flow chart of FIG. 11, where the user 120 toggles the mobile electronic device 200A, 200B containing the digital/logical payment card 110 to operate in the card-operation mode.

Next, at 11-10, the user 120 is prompted by the vendor to present their digital/logical payment card 110 to effect transaction.

At 11-15, the user 120 selects one of the payment schemes 100A-D linked to the user's digital/logical payment card 110 to effect transaction. Accordingly, the user 120 presses preset ‘4’ using the virtual keypad 315.

At 11-20, upon pressing preset ‘4’, the virtual screen 325 displays “MASTRCARD1”, as illustrated by screen 1010 (FIG. 10), to confirm to the user 120 that preset ‘4’ corresponds to their Mastercard™ account. The user 120 is then prompted to indicate to the digital/logical payment card 110 what kind of transaction is to be conducted, as exemplarily illustrated by screen 1020 (FIG. 10). Accordingly, the user 120 in this example indicates to the card that a point-of-sale transaction is to be made. This indication can be made by way of a manipulation of the virtual keypad 315 in a known sequence. In one form, the button ‘2’ is pressed to indicate a point-of-sale transaction.

At 11-25, the user 120 validates their authority to use the digital/logical payment card 110. The user's authority can be validated conventionally, for example by way of the insertion or swiping of the digital/logical payment card 110 into the POS device 150, subsequently entering a PIN into the POS device 150, and offline or online verification of the PIN. In a preferred form, however, the user's authority is validated using a dynamic one-time PIN as illustrated by screen 1030 (FIG. 10). The use of a dynamic one-time PIN to validate the user's authority is described in PCT application No. PCT/AU2012/000110 (published as WO2012/106757), the contents of which are herein incorporated by reference.

At 11-30, upon successful validation of the user's authority, details of the digital/logical payment card 110 and other transaction details are read or entered into the POS device 150 and sent to the wallet server 130. In particular, the PAN corresponding to preset ‘4’ of the digital/logical payment card 110 is sent to the wallet server 130.

At 11-35, the wallet server 130 receives the PAN and transaction details, and derives from the PAN that the user 120 pressed preset ‘4’. Accordingly, the wallet server 130 retrieves the user's Mastercard™ account details and provides the account details and transaction details to the Mastercard™ financial system 105B for processing.

At 11-40, the Mastercard™ financial system 105B processes the transaction and either accepts or declines the transaction pursuant to their standard procedures.

A notification of acceptance or rejection of the transaction is then provided back to the wallet server 130, who in turn notifies the vendor/POS device 150.

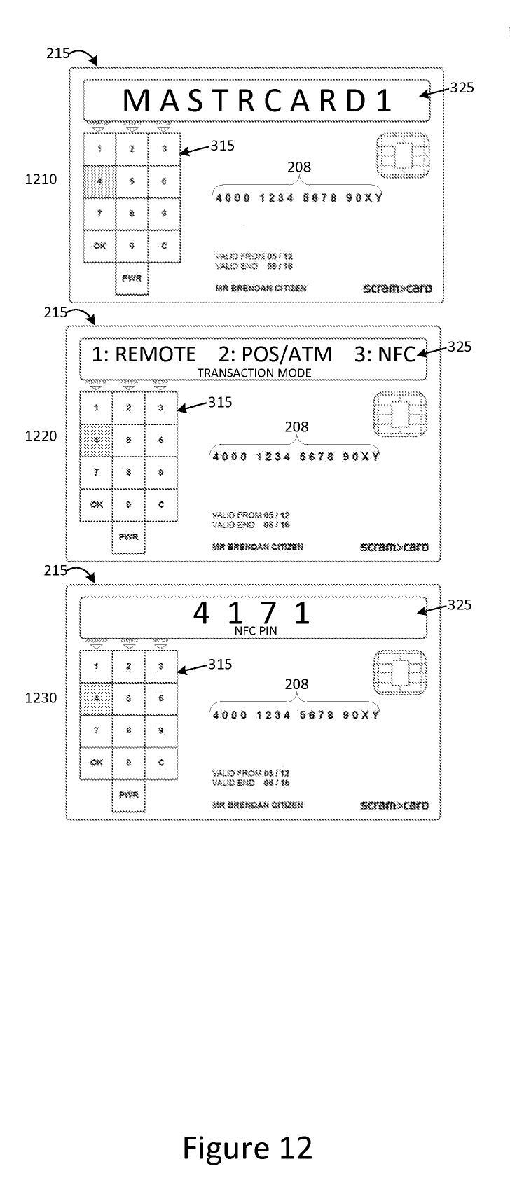

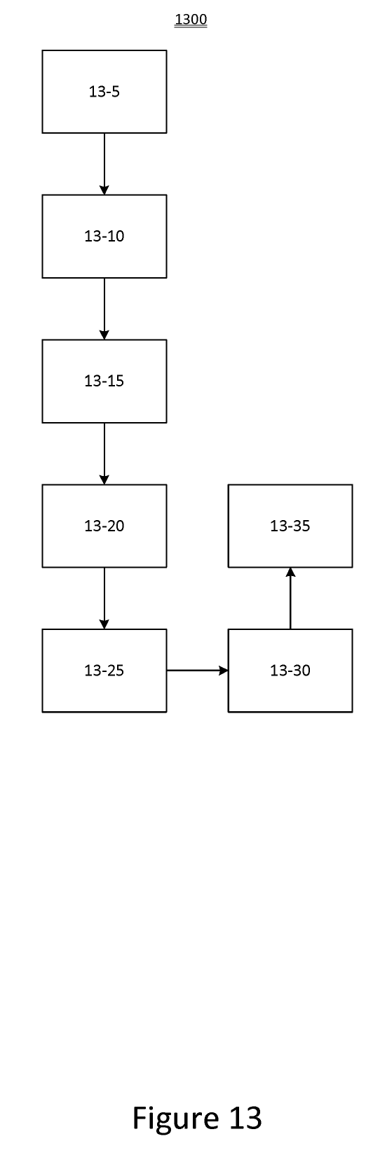

With reference to FIGS. 12 and 13, an operation 1300 for making an NFC tap transaction is described. An NFC tap transaction, for the purposes of this description, is one where the digital/logical payment card 110 is physically presented to the vendor 155, similar to that of an POS/ATM transaction but where the digital/logical payment card 110 communicates to the POS device 150 by Near Field Communication (NFC) technology rather than the digital/logical payment card 110 being read by insertion into the POS device 150.

For convenience of description, it is assumed in the following description that the user 120 desires to effect transaction by way of their Mastercard™ credit card which has been linked to preset ‘4’ of their digital/logical payment card 110. It is to be understood, however, that the invention is not so limited, and that the following operation 800 is applicable regardless of which payment scheme is used, and which preset of the digital/logical payment card 110 is activated.

The operation 1300 commences at 13-5, where the user 120 toggles the mobile electronic device 200 containing the digital/logical payment card 110 to operate in the card-operation mode.

Next at 13-10, the user 120 is prompted by the vendor 155 to present their digital/logical payment card 110 to effect transaction.

At 13-15, the user 120 selects one of the payment schemes 100A-D linked to the user's digital/logical payment card 110 to effect transaction. Accordingly, the user 120 presses preset ‘4’ using the keypad 220.

At 13-20, upon pressing preset ‘4’, the virtual screen 325 displays “MASTRCARD1”, as illustrated by screen 1210 (FIG. 12), to confirm to the user 120 that preset ‘4’ corresponds to their Mastercard™ account. The user 120 is then prompted to indicate to the digital/logical payment card 110 what kind of transaction is to be conducted, as exemplarily illustrated by screen 1220 (FIG. 12). Accordingly, the user 120 in this example indicates to the card that a NFC tap transaction is to be made. This indication can be made by way of a manipulation of the virtual keypad 315 in a known sequence. In one form, the button ‘3’ is pressed to indicate an NFC tap transaction.

At 13-25, the user 120 is prompted by the digital/logical payment card 110 to enter a PIN, as illustrated by screen 1230 (FIG. 12). The PIN validates the user 120 to the digital/logical payment card 110, thereby authorizing and unlocking the NFC function of the digital/logical payment card 110 to conduct an NFC transaction. The requirement for the PIN secures the digital/logical payment card 110 from unauthorized NFC transactions.

At 13-30, upon successful validation of the user's authority to conduct an NFC transaction, the user 120 positions the digital/logical payment card 110 in the vicinity of a NFC enabled POS device 150. Details of the digital/logical payment card 110 and other transaction details are transmitted to the POS device 150 via NFC communications, and subsequently sent by the POS device 150 to the wallet server 130. In particular, the PAN corresponding to preset ‘4’ of the digital/logical payment card 110 is sent to the wallet server 130.

At 13-35, the wallet server 130 receives the PAN and transaction details, and derives from the PAN that the user 120 pressed preset ‘4’. Accordingly, the wallet server 130 retrieves the user's Mastercard™ account details and provides the account details and transaction details to the Mastercard™ financial system 105B for processing.

At 13-40, the Mastercard financial system 105B processes the transaction and either accepts or declines the transaction pursuant to their standard procedures. A notification of acceptance or rejection of the transaction is then provided back to the wallet server 130, who in turn notifies the vendor/POS device 150.

The system 10, digital/logical payment card 110, mobile electronic device 200A, 200B, and use thereof according to the present disclosure enables the user 120 to effect transaction via multiple payment schemes 100A-D that the user 120 has accounts with, using a single device that the user 120 is likely to already be carrying.

The electronic circuits making up the payment card circuit 101 are kept isolated and separated from the electronic circuits 270, 280, 290, 295 of the mobile electronic device proper 201, whereby malicious or accidental compromise of financial information stored in the digital/logical payment card 110 and financial operations being performed by the digital/logical payment card 110 are prevented, or at least ameliorated.

The electronic circuits of the payment card circuit 101 and the mobile device circuit 201 can be kept separated and isolated by each being independent of each other completely, including each having their own display and at most sharing a power source. The mobile electronic device 200A of the preferred embodiment is an example of a mobile electronic device utilizing this arrangement to effect separation and isolation. An advantage of this arrangement is that the mobile electronic device can operation in both the card-operation mode and the device-operation mode simultaneously, if desired.

Additionally, with this arrangement, and further by configuring the payment card circuit 101 as a dockable chip 242, digital/logical payment cards 110 can be readily swapped in and out, for example to allow for multiple users, multiple accounts (e.g. personal and business), and/or to more readily allow for upgrades and advances in technology.

The switch 260 is another manner by which the electronic circuits 210, 220, 230, 240, 250, 255, 211 making up the digital/logical payment card 110 can be kept isolated and separated from the electronic circuits 270, 280, 290, 295 of the mobile electronic device proper 201. The mobile electronic device 200B of the second embodiment is an example of a mobile electronic device utilizing the switch 260 to effect electronic isolation and separation.

It is to be understood that the switch 260 can be mechanical, physical, logical, and/or digital. The switch 260 can, for example, be in the form of an appropriate software application running on the mobile electronic device 200 which, when run/executed, effects virtual separation/isolation of the electronic circuits 210, 220, 230, 240, 250, 255, 211 from the electronic circuits 270, 280, 290, 295.

The electronic circuits 210, 220, 230, 240, 250, 255, 211 of the digital/logical payment card 110 and the electronic circuits 270, 280, 290, 295 of the mobile electronic device proper 201 can also share the same physical hardware/circuitry. In this case, separation/isolation is achieved by way of a software/logical separation, for example using a virtual machine.

The digital/logical payment card 110 stores therein a plurality of card extension numbers used to generate a plurality of unique PANs, one for each preset on the digital/logical payment card 110 that can be linked with a payment scheme account. Each PAN corresponds with a payment scheme account stored in the wallet server 110. The card extension numbers, when substituted for the variable digits in the card number 208, form the PANs issued to the wallet card 110 by the payment standard and identify to the wallet server 130 which preset has been pressed by the user 120. Accordingly, the wallet server 130 is able to retrieve the actual account details for the payment scheme account corresponding to the identified preset and submit the actual account details to the appropriate financial system 105A-D for processing.

The PANs conform to the payment standard, for example the Mastercard™ standard. The PANs are selected by the wallet provider from a range of numbers dictated by the standards provider (e.g. Mastercard™), and accordingly, each PANs is a valid number recognizable by any POS device or payment system that accepts the standard. In a preferred form of the present invention, up to ten valid PANs are selected by the wallet provider to be issued with each digital/logical payment card 110.

From the vendor's/POS device's point of view, the user 120 is effecting transaction by the payment scheme represented by the PAN (e.g. Mastercard™) even if a different payment scheme is contacted by the wallet server 130 to effect the transaction. Accordingly, the present invention further allows the user 120 to pay by a preferred, though less widely accepted, payment scheme such as American Express™, even when the vendor 155 does not accept transactions by that payment scheme.

### ADVANTAGES

The advantages of the present invention include the ability for users to transact using any payment scheme with which they have an account, from a single device which the user is likely to already own or need. Accordingly, there is no longer the need for users to carry with them multiple cards, or any cards at all.

Moreover, the present invention allows users to essentially transact with a vendor using a payment scheme that the vendor does not accept. Accordingly, payment schemes such as Diners Club™ and American Express™ which tend to offer better incentives to users but which are not widely accepted, my still be used by users at vendors which do not accept such payment schemes.

The present invention further obviates the need for collaboration or agreement between the various payment schemes. The technological solution presented by the present invention hence renders feasible what would otherwise be, from a business perspective, an unfeasible solution.

### VARIATIONS

It will of course be realised that while the foregoing has been given by way of illustrative example of this invention, all such and other modifications and variations thereto as would be apparent to persons skilled in the art are deemed to fall within the broad scope and ambit of this invention as is herein set forth.

Throughout the description and claims of this specification the word “comprise” and variations of that word such as “comprises” and “comprising”, are not intended to exclude other additives, components, integers or steps.

1. A mobile electronic device configured to perform an intended purpose and further configured to effect a financial transaction in addition to the intended purpose, the device comprising:
a first group of electronic circuits configured to facilitate the performing of the intended purpose; and
a second group of electronic circuits configured to effect the financial transaction, wherein
the first group of electronic circuits is communicatively isolated from the second group of electronic circuits, and
the second group of electronic circuits is operable to generate a one-time passcode (OTP) for authenticating the financial transaction and to display the generated OTP on a display of the mobile electronic device.

2. A device according to claim 1, wherein when input and output to and from the first group of electronic circuits is permitted, input and output to and from the second group of electronic circuits is denied.

3. A device according to claim 1, wherein the second group of electronic circuits includes an EMV (Europay, Mastercard, Visa) standard integrated circuit for effecting financial transactions using the EMV payment standard.

4. A device according to claim 1, wherein the second group of electronic circuits includes an electronic dock adapted to removably receive therein an electronic chip, the electronic chip containing some or all of the electronic circuits of the second group.

5. A device according to claim 2, further comprising a switch for switching between a first mode of operation where input and output to and from the first group of electronic circuits is permitted, and a second mode of operation where input and output to and from the second group of electronic circuits is permitted.

6. A device according to claim 1, wherein input and output to and from the first group of electronic circuits is permitted at the same time that input and output from the second group of electronic circuits is permitted.

7. A device according to claim 1, wherein the first group of electronic circuits comprises a near-field-communication (NFC) receiver and the second group of electronic circuits comprises an NFC transmitter, and further wherein the second group of electronic circuits is operable to communicate data to the first group of electronic circuits via NFC communication.

8. A device according to claim 1, wherein the first group of electronic circuits is communicatively isolated from the second group of electronic circuits by way of a logical virtual machine architecture.

9. A device according to claim 1, wherein the first group of electronic circuits is communicatively isolated from the second group of electronic circuits by a physical separation.

10.-11. (canceled)

12. A device according to claim 7, wherein the second group of electronic circuits is operable to broadcast the OTP via NFC and the first group of electronic circuits is operable to monitor NFC broadcasts for OTPs.

13. A mobile electronic device configured to perform an intended purpose and further configured to effect a financial transaction in addition to the intended purpose, the device comprising:
a first group of electronic circuits configured to facilitate the performing of the intended purpose; and
a second group of electronic circuits configured to effect the financial transaction, wherein
the first group of electronic circuits is communicatively isolated from the second group of electronic circuits, and
the first group of electronic circuits comprises a near-field-communication (NFC) receiver and the second group of electronic circuits comprises an NFC transmitter, and further wherein the second group of electronic circuits is operable to communicate data to the first group of electronic circuits via NFC communication.

14. A mobile electronic device configured to perform an intended purpose and further configured to effect a financial transaction in addition to the intended purpose, the device comprising:
a first group of electronic circuits configured to facilitate the performing of the intended purpose; and
a second group of electronic circuits configured to effect the financial transaction, wherein
the first group of electronic circuits is communicatively isolated from the second group of electronic circuits, and
the second group of electronic circuits includes an electronic dock adapted to removably receive therein an electronic chip, the electronic chip containing some or all of the electronic circuits of the second group.

15. A mobile electronic device configured to perform an intended purpose and further configured to effect a financial transaction in addition to the intended purpose, the device comprising:
a first group of electronic circuits configured to facilitate the performing of the intended purpose; and
a second group of electronic circuits configured to effect the financial transaction, wherein
the second group of electronic circuits is operable to generate a one-time passcode (OTP) for authenticating the financial transaction and to broadcast the OTP via NFC, and
the first group of electronic circuits is operable to monitor NFC broadcasts for OTPs.

16. A device according to claim 2, wherein the second group of electronic circuits includes an EMV (Europay, Mastercard, Visa) standard integrated circuit for effecting financial transactions using the EMV payment standard.
